(19) United States
(12) Patent Application Publication
(10) Pub. No.: US 2005/0226628 A1
(43) Pub. Date: Oct. 13, 2005

(54) Method and device for wavelength dispersion compensation

(75) Inventor: Kenji Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/942,903

(22) Filed: Sep. 17, 2004

(30) Foreign Application Priority Data
Mar. 30, 2004 (JP) 2004-101101

(51) Int. Cl. H04B 10/12

(52) U.S. Cl. 398/147

(57) ABSTRACT

A method of wavelength dispersion compensation is disclosed that is able to suppress the cost with a simple configuration without providing a light source on the transmitting side for generating optical signals for measurement use. In the transmitting device, excitation light is intermittently output to an optical amplifier for amplification of an optical signal to be transmitted, and an wavelength-dispersion-detection optical signal is output to an optical transmission path. In a receiving device, light components having different wavelengths are extracted from the wavelength-dispersion-detection optical signal transmitted through the optical transmission path, a difference in propagation time of the light components having different wavelengths through the optical transmission path is obtained, and a value of wavelength dispersion of a wavelength-dispersion-variable element is adjusted so that the difference in propagation time becomes zero. With the obtained value of wavelength dispersion, wavelength dispersion in the optical transmission path is compensated for.

### BACKGROUND OF THE INVENTION

1. Field of the Invention

The present invention relates to a method and a device for wavelength dispersion compensation, and particularly, to a method and a device capable of automatically compensating for wavelength dispersion occurring in an optical fiber in a Wavelength Division Multiplexing (WDM) transmission system.

2. Description of the Related Art

In a WDM (Wavelength Division Multiplexing) transmission system, optically modulated signals are multiplexed by means of WDM and are transmitted in a C-band (1530 to 1570 nm) and an L-band (1570 to 1610 nm) at a super high speed around 10 Gbps over long distances. In this system, depending on wavelengths of the optical signals, difference of propagation time occurs in optical fibers, which form an optical transmission path. This phenomenon is called “wavelength dispersion”. In practical use, the wavelength dispersion should be compensated so as to suppress the wavelength dispersion to a level tolerable by the system. Usually, it is necessary to adjust suppress the wavelength dispersion to be near zero.

FIG. 1 is a block diagram showing a configuration of an optical WDM transmission system in the related art, which is capable of wavelength dispersion compensation.

As illustrated in FIG. 1, in an optical WDM transmission system, WDM transmission devices 10 and 12 are connected by an optical fiber transmission path 11. In the optical fiber transmission path 11, wavelength dispersion occurs. A fiber 13 is provided in the WDM transmission device 12 to generate wavelength dispersion having the same absolute value as, but an opposite sign to that of the wavelength dispersion occurring in the optical fiber transmission path 11. The fiber 13 is thus referred to as “Dispersion Compensation Fiber (DCF)”. Due to the fiber 13, the wavelength dispersion in the optical fiber transmission path 11 is compensated.

FIG. 2 is a diagram showing the principle of wavelength dispersion compensation.

In FIG. 2, the solid line I represents positive wavelength dispersion, which occurs in a single mode fiber (SMF), for example, used as the optical fiber transmission path 11. The solid line II represents negative wavelength dispersion, which is generated by the dispersion compensation fiber 13.

In order to compensate for the positive wavelength dispersion in the single mode fiber (SMF) represented by the solid line I, the negative wavelength dispersion generated in the dispersion compensation fiber 13 represented by the solid line II can be utilized. Specifically, the length of the dispersion compensation fiber 13 can be appropriately adjusted so that the wavelength dispersion generated in the dispersion compensation fiber 13 has the same absolute value as the wavelength dispersion in the single mode fiber. Then, if the dispersion compensation fiber 13 and the single mode fiber are connected in series, the wavelength dispersion can be compensated.

Japanese Laid-Open Patent Application No. 2002-77053 discloses an invention related to this technique. For example, as illustrated in FIG. 3 of this reference, a desired value of the wavelength dispersion is imposed on a received optical signal. Then this modulated optical signal is converted to an electrical signal to obtain transmission data. While monitoring intensity of a specified frequency component of the transmission data, a wavelength-dispersion-variable element is adjusted so that a monitoring signal becomes a maximum to carry out automatic wavelength dispersion compensation.

Alternatively, the value of the wavelength dispersion in the optical fiber transmission path may be measured, and the wavelength dispersion variable element may be controlled based on the measured value.

International Publication W001/005005 discloses a method of automatic compensation for gain-tilt, which means level differences with wavelengths after transmission. The gain-tilt occurs due to a slope of wavelength-transmission loss in an optical fiber, and a slope of the wavelength-gain characteristic of an optical amplifier in a DWDM (Dense Wavelength Division Multiplexer) system.

Japanese Laid-Open Patent Application No. 5-152645 discloses an invention in which wavelength dispersion and transmission loss in an optical fiber are compensated for at the same time, and ions of rare-earth elements are added in the dispersion compensation fiber to obtain a function of optical amplification.

The system utilizing the dispersion compensation fiber, as illustrated in FIG. 1, provides a very simple method of wavelength dispersion. However, this method is not applicable in some cases as shown below.

In the past time, the wavelength dispersion did not cause any severe problem in optical communication, and for old optical fiber transmission paths, which were built in that past time and are still in operation presently, in most cases, one cannot find accurate distances, for example, between transmitters and receivers, transmitters and transponders, transponders and other transponders, and transponders and receivers. In addition, one cannot find the accurate value of the wavelength dispersion in the optical fibers, either.

For this reason, when constructing a new super high speed optical WDM transmission system by using the old optical fiber transmission path, one has to measure the wavelength dispersion in the optical fiber transmission path, and prepare a wavelength dispersion compensation fiber beforehand based on the measured value of the wavelength dispersion. This is quite cumbersome and time consuming.

In addition, after the super high speed optical WDM transmission system is constructed, and when it is necessary to change an optical fiber transmission path therein, one has to re-measure the wavelength dispersion in the optical fiber transmission path to be used, and prepare a new wavelength dispersion compensation fiber. This is also quite cumbersome and time consuming.

FIG. 3 is a block diagram of a configuration suitable for automatic wavelength dispersion compensation.

Automatic wavelength dispersion compensation as illustrated in FIG. 3 is an ideal method for wavelength dispersion compensation, but the system requires an element for adding wavelength dispersion in addition to a wavelength dispersion variable element. Hence, the cost of the system in FIG. 3 is high.

It is effective to measure the wavelength dispersion in the optical fiber transmission path, and automatically control the wavelength dispersion variable element based on the measured value. As for methods of measuring the wavelength dispersion in the optical fiber transmission path, for example, a method is proposed which involving inputting optical pulses or optical signals having different wavelengths (these are referred to as “probe light”) to an optical fiber transmission path, and measuring differences of propagation time of the optical signals having different wavelengths in the outgoing optical signal.

In order to implement this method, however, one has to prepare a set of wavelength dispersion measurement devices in each transmission section and to perform additional wavelength division multiplexing on optical signals of different wavelengths used for wavelength dispersion measurement besides multiplexing the optical signals having intensity modulated according to transmission data. For this reason, the scale of the devices constituting the optical communication system becomes vary large, and this increases the cost of the system.

### SUMMARY OF THE INVENTION

It is a general object of the present invention to solve one or more of the problems of the related art.

It is a more specific object of the present invention to provide a method and devices that are capable of automatic wavelength dispersion compensation and suppressing the cost with a simple configuration without providing a light source on a transmitting side for generating optical signals for measurement use.

According to a first aspect of the present invention, there is provided a method of wavelength dispersion compensation including the steps of intermittently outputting, in a transmitting device, excitation light to an optical amplifier for amplification of an optical signal to be transmitted; outputting, in the transmitting device, an wavelength-dispersion-detection optical signal to an optical transmission path; extracting, in a receiving device, light components having different wavelengths from the wavelength-dispersion-detection optical signal received through the optical transmission path; finding, in the receiving device, a difference in propagation time of the light components having different wavelengths through the optical transmission path; and adjusting, in the receiving device, a value of wavelength dispersion of a wavelength-dispersion-variable element so that said difference becomes zero so as to compensate for wavelength dispersion in the optical transmission path.

As an embodiment, the transmitting device outputs a wavelength-multiplexed signal to the optical transmission path.

As a second aspect of the present invention, there is provided a transmitting device including a first switching unit that intermittently outputs excitation light to an optical amplifier for amplification of an optical signal to be transmitted. The transmitting device outputs an wavelength-dispersion-detection optical signal generated in the optical amplifier to an optical transmission path.

As an embodiment, the transmitting device further comprises a second switching unit that prevents the optical signal to be transmitted from being output to the optical amplifier.

As a third aspect of the present invention, there is provided a receiving device including a wavelength-dispersion-variable element that performs wavelength dispersion compensation on an optical signal received through an optical transmission path; an extraction unit that extracts light components having different wavelengths from an wavelength-dispersion-detection optical signal transmitted from the wavelength-dispersion-variable element; a wavelength dispersion controller that finds a difference in propagation time of the light components having different wavelengths through the optical transmission path, and adjusts a value of wavelength dispersion of the wavelength-dispersion-variable element so that said difference becomes zero.

As an embodiment, the receiving device further includes a switching unit that prevents optical signal output from the wavelength dispersion controller from being output to the outside.

As an embodiment, the wavelength dispersion controller includes an optical-electrical conversion unit that converts a first light component having a first wavelength and a second light component having a second wavelength to a first detection signal and a second detection signal, respectively, said first light component and said second light component being extracted by the extraction unit; a calculation unit that sets a polarity of the first detection signal to be opposite to a polarity of the second detection signal, and sums the first detection signal and the second detection signal; an A/D conversion unit that digitizes an output signal from the calculation unit; and a control unit that finds a difference in propagation time of the first detection signal and the second detection signal, and adjusts a value of wavelength dispersion of the wavelength-dispersion-variable element so that said difference becomes zero.

These and other objects, features, and advantages of the present invention will become more apparent from the following detailed description of the preferred embodiments given with reference to the accompanying drawings.

### BRIEF DESCRIPTION OF THE DRAWINGS

FIG. 1 is a block diagram showing a configuration of an optical WDM transmission system in the related art, which is capable of wavelength dispersion compensation;

FIG. 2 is a diagram showing the principle of wavelength dispersion compensation;

FIG. 3 is a block diagram showing a configuration suitable for automatic wavelength dispersion compensation;

FIG. 4 is a block diagram showing an exemplary configuration of an optical WDM transmission system according to an embodiment of the present invention;

FIG. 5 is a block diagram showing exemplary configurations of the wavelength dispersion compensation controllers 23 and 31;

FIG. 6 is a view showing an exemplary waveform of the ASE light;

FIG. 7 is a view showing an exemplary optical spectrum of the ASE light;

FIG. 8 is a view of an exemplary waveform of a summed signal;

FIG. 9 is a view of exemplary waveforms illustrating a difference in propagation time caused by wavelength difference in the optical fiber transmission path 25; and

FIG. 10 is a schematic view showing results of wavelength dispersion compensation when the wavelength-dispersion-variable element 49 is provided in the receiving side of the optical fiber transmission path 25.

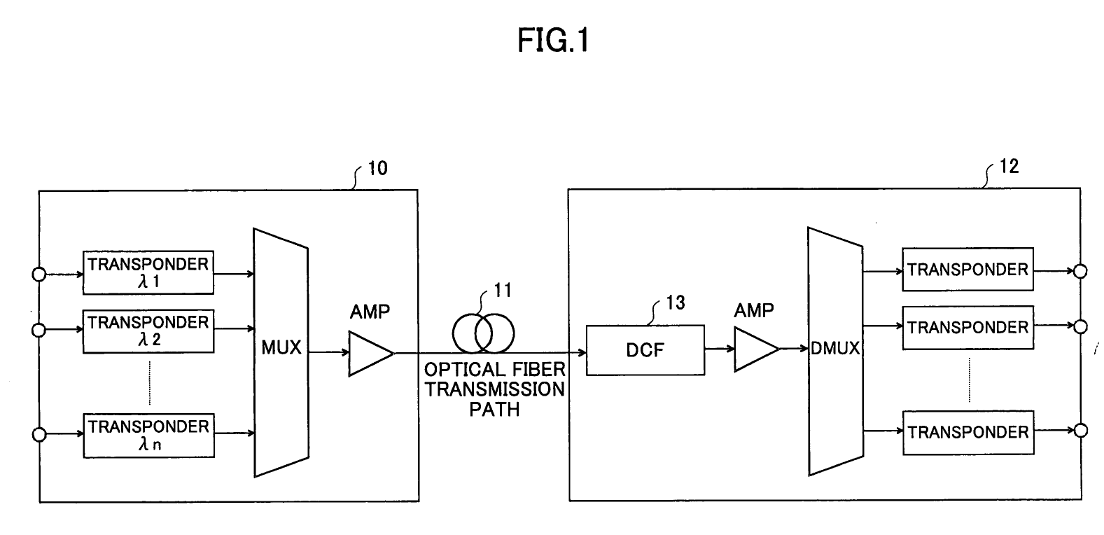

### DESCRIPTION OF THE PREFERRED EMBODIMENTS

Below, preferred embodiments of the present invention are explained with reference to the accompanying drawings.

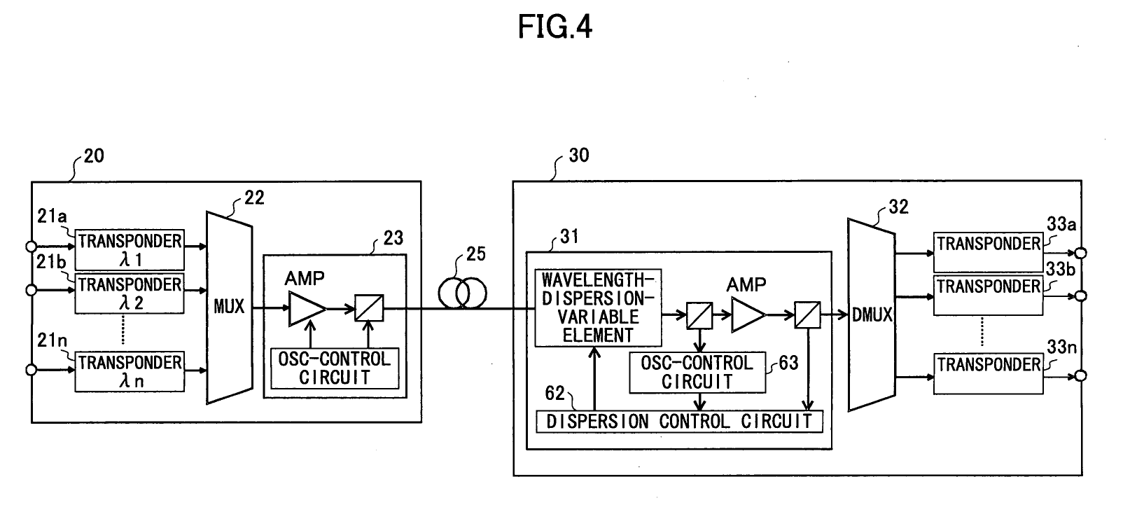

FIG. 4 is a block diagram showing an exemplary configuration of an optical WDM transmission system according to an embodiment of the present invention.

As illustrated in FIG. 4, in the optical WDM transmission system of the present embodiment, a WDM transmission device 20 acting as a transmitter is connected with a WDM transmission device 30 acting as a receiver by an optical fiber transmission path 25.

The WDM transmission device 20 includes transmitting transponders 21a through 21n, a wavelength multiplexer 22, and a wavelength dispersion compensation controller 23.

The transmitting transponders 21a through 21n transform optical signals supplied from outside, such as SONET (Synchronous Optical Network) signals or GbE (Gigabit Ethernet (registered trademark)) signals, to optical signals in a narrow band and having different wavelengths λ1 through λn for the purpose of wavelength multiplexing. The transmitting transponders 21a through 21n transmit the optical signals having wavelengths λ1 through λn to the wavelength multiplexer 22.

The wavelength multiplexer 22 multiplexes the optical signals by means of WDM (Wavelength Division Multiplexing), and the thus obtained optical signal is transmitted to the wavelength dispersion compensation controller 23.

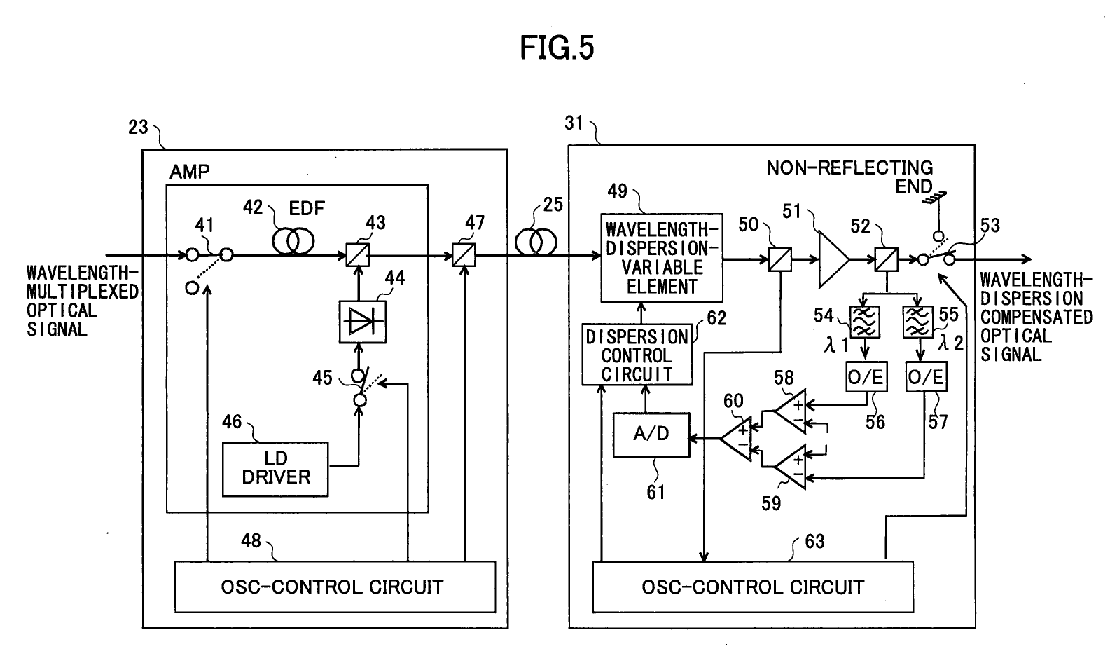

In the wavelength dispersion compensation controller 23, the wavelength-multiplexed optical signal from the wavelength multiplexer 22 is amplified by an optical amplifier 42 (refer to FIG. 5), and is transmitted to the optical fiber transmission path 25 for long distance transmission.

The WDM transmission device 30 includes a wavelength dispersion compensation controller 31, a wavelength de-multiplexer 32, and receiving transponders 33a through 33n.

The wavelength dispersion compensation controller 31 receives the wavelength-multiplexed optical signal from the optical fiber transmission path 25.

In the wavelength dispersion compensation controller 31, the wavelength-multiplexed optical signal is amplified by an optical amplifier 51 (refer to FIG. 5), and is transmitted to the wavelength de-multiplexer 32.

The wavelength de-multiplexer 32 separates the wavelength-multiplexed optical signal into a plurality of optical signals having different wavelengths λ1 through λn, and transmits the optical signals having different wavelengths λ1 through λn to the receiving transponders 33a through 33n, respectively.

Each of the receiving transponders 31a through 31n transforms the optical signals having different wavelengths λ1 through λn into, for example, SONET signals or GbE signals, and outputs the obtained SONET signals or GbE signals.

FIG. 5 is a block diagram showing configurations of the wavelength dispersion compensation controllers 23 and 31.

In the wavelength dispersion compensation controller 23, which is on the transmitting side, an optical signal having a wideband spectrum is generated for measuring the wavelength dispersion occurring in the optical fiber transmission path 25.

The wavelength-multiplexed optical signal from the wavelength multiplexer 22 is transmitted to the optical amplifier 42 via an optical switch 41. For example, the optical amplifier 42 is an EDF (Erbium Doped Fiber). The optical amplifier 42 receives, through an optical combiner 43, an excitation optical signal generated by a pump LD (laser diode) 44. Upon receiving the excitation optical signal, the optical amplifier 42 amplifies the wavelength-multiplexed optical signal.

The pump LD 44 receives, through an electrical switch 45, a driving current from an LD driver 46. Upon receiving the driving current, the pump LD 44 is driven to emit light.

The wavelength-multiplexed optical signal amplified by the optical amplifier 42 is transmitted from the optical combiner 43 to an optical combiner 47. An OSC optical signal is input to the optical combiner 47 from an OSC-control circuit 48.

The optical combiner 47 combines the amplified wavelength-multiplexed optical signal and the OSC optical signal, and transmits the resulting optical signals to the optical fiber transmission path 25.

The OSC-control circuit 48 generates the OSC (Optical Supervisor Channel) optical signal, which is used for communication during the operation of adjusting the wavelength dispersion between the wavelength dispersion compensation controllers 23 and 31. The OSC-control circuit 48 also controls the switches 41 and 45, that is, sets the switches 41 and 45 ON or OFF, during the operation of automatic control of the wavelength dispersion.

The wavelength dispersion compensation controller 31, which is on the receiving side, detects the value of the wavelength dispersion imposed on the optical signal having a wideband spectrum when this optical signal propagates in the optical fiber transmission path 25. Based on the measured value of the wavelength dispersion, the wavelength dispersion compensation controller 31 controls a wavelength-dispersion-variable element 49 to perform wavelength dispersion compensation.

The wavelength-dispersion-variable element 49 receives the wavelength-multiplexed optical signal from the optical fiber transmission path 25. As the wavelength-dispersion-variable element 49, for example, use may be made of the device proposed in Japanese Laid-open Patent Application No. 2002-258207 by the inventor of the present invention. In such a wavelength-dispersion-variable element 49, angularly dispersed light beams having different wavelengths output from a VIPA (Virtually Imaged Phased Array) are focused by a lens, and are diffracted by a pair of gratings for generating light path deviations and for altering the light path deviations, thereby generating deviations in light paths related to different wavelengths. The light beams are reflected on dispersing flat three-dimensional mirrors and are returned to the VIPA plate. Consequently, it is possible to obtain different wavelength dispersion for each wavelength because of the wavelength dependence of the light path caused by the three-dimensional mirror, enabling adjustments of the value of the wavelength dispersion and the wavelength dispersion slope over the entire wavelength region of the wavelength-multiplexed optical signals.

As the wavelength-dispersion-variable element 49, use may also be made of an optical fiber grating, which has a diffractive grating at the core thereof, and is able to control the value of the wavelength dispersion by controlling a temperature and a stress imposed on an optical fiber.

The optical signal transmitted from the wavelength-dispersion-variable element 49 is input to an optical splitter 50.

The optical splitter 50 splits the received optical signal, thereby obtaining the wavelength-multiplexed optical signal and the OSC signal used for communication during the operation of adjusting the wavelength dispersion between the wavelength dispersion compensation controllers 23 and 31. The wavelength-multiplexed optical signal split by the optical splitter 50 is input to the optical amplifier 51, and the OSC signal is input to an OSC-control circuit 63.

The optical amplifier 51 amplifies the received optical signal, and transmits the amplified optical signal to an optical splitter 52.

The optical splitter 52 splits the received optical signal into a large portion and a small portion. The large portion of the optical signal from the optical splitter 52 is output as the object signal through an optical switch 53, and the small portion of the optical signal from the optical splitter 52 is input as a sample to optical band-pass filters 54 and 55 for the purpose of dispersion measurement.

Here, when the optical switch 53 is turned off, the input optical signal is terminated without reflection, and this prevents the incident light from being reflected and returned to the optical amplifier 51.

The optical band-pass filters 54 and 55 respectively extract optical signals having wavelengths λ1 and λ2 in a narrow-band from the sample of the optical signal, and these optical signals are used as probe optical signals.

These probe optical signals extracted by the optical band-pass filters 54 and 55 are input to optical-electrical converters (O/E) 56 and 57, respectively, and are converted to electrical signals, denoted to be λ1 and λ2, respectively. The electrical signals λ1 and λ2 function as detection signals for use of measurement. These detection signals λ1 and λ2 are input to differential amplifiers 58 and 59, respectively.

The detection signal λ1 is input to a non-inverted terminal of the differential amplifier 58, and the detection signal λ2 is input to an inverted terminal of the differential amplifier 59. A reference level, for example, 0 V, is input to an inverted terminal of the differential amplifier 58 and a non-inverted terminal of the differential amplifier 59. Therefore, the differential amplifiers 58 and 59 output detection signal λ1 and the detection signal λ2 which are opposite in polarity.

These detection signal λ1 and the detection signal λ2 are input to an cumulative amplifier 60, and are summed wherein. The summed signal is input to an A/D converter 61. The A/D converter 61 digitizes the input signal and outputs the resulting signal to a dispersion control circuit 62.

The dispersion control circuit 62 measures a time difference between a timing of detecting the detection signal λ1 and a timing of detecting the detection signal λ2 in the summed signal, and adjusts the dispersion value of the wavelength-dispersion-variable element 49 so that the time difference becomes zero.

For example, if the optical fiber transmission path 25 involves positive wavelength dispersion, and if the time difference is large, the dispersion of the wavelength-dispersion-variable element 49 is adjusted to be negative and have a large absolute value.

The OSC-control circuit 63 receives the OSC optical signal used for communication during the operation of adjusting the wavelength dispersion between the wavelength dispersion compensation controllers 23 and 31. In addition, the OSC-control circuit 63 also controls ON/OFF of the switch 53 during the operation of automatic wavelength dispersion control.

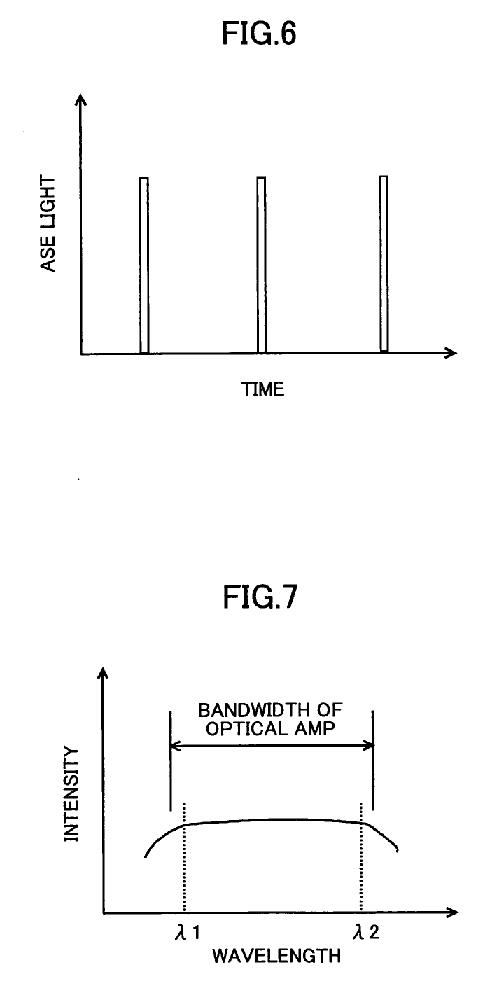

For example, after an optical WDM transmission system is constructed, or after an optical fiber transmission path is changed in an optical WDM transmission system, and when the WDM transmission devices 20 and 30 are powered on, in the WDM transmission device 20, the OSC-control circuit 48 sets the optical switch 41 OFF. Under this condition, the electrical switch 45 is set ON periodically with the period being very short to drive the pump LD 44. As a result, the optical amplifier 42, which is formed by EDF, generates ASE (Amplified Spontaneous Emission) light which has a waveform as illustrated in FIG. 6. The ASE light is output to the optical fiber transmission path 25.

FIG. 6 is a view showing a waveform of the ASE light.

The optical spectrum of the ASE light output to the optical fiber transmission path 25 is illustrated in FIG. 7.

As illustrated in FIG. 7, the optical spectrum of the ASE light is flat in the whole operation bandwidth of the optical amplifier 42, that is, the ASE light is a wide-band optical signal, and is used for measurement of the wavelength dispersion in the optical fiber transmission path 25, as described above.

On the other hand, in the WDM transmission device 30, the OSC-control circuit 63 sets the optical switch 53 OFF.

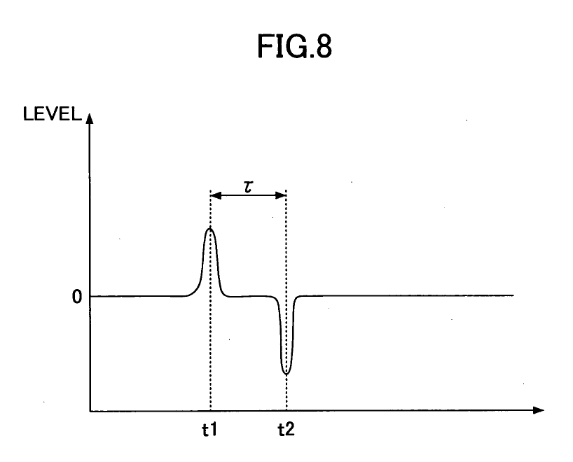

Then, the dispersion control circuit 62 measures the time difference τ between the detection signal λ1 and the detection signal λ2 in the summed signal illustrated in FIG. 8.

FIG. 8 is a view of an exemplary waveform of the summed signal.

In the summed signal as illustrated in FIG. 8, the dispersion control circuit 62 measures the time difference τ between a detection timing t1 of the detection signal λ1 and a detection timing t2 of the detection signal λ2, and adjusts the dispersion of the wavelength-dispersion-variable element 49 so that the time difference τ becomes zero. When the time difference τ becomes zero, the dispersion control circuit 62 stores the resulting value of the dispersion.

Then, the OSC-control circuit 48 of the WDM transmission device 20 sets the switches 41 and 45 ON to transit to usual operation of the system, and the OSC-control circuit 63 of the WDM transmission device 30 sets the optical switch 53 ON, and the dispersion value of the wavelength-dispersion-variable element 49 is adjusted to be the dispersion value stored in the dispersion control circuit 62.

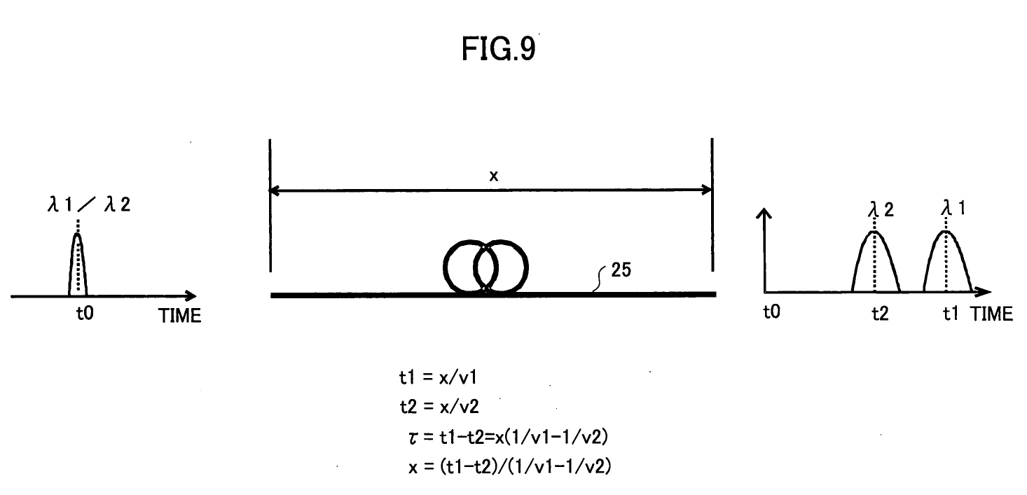

FIG. 9 is a view of waveforms illustrating the propagation time difference caused by wavelength difference in the optical fiber transmission path 25.

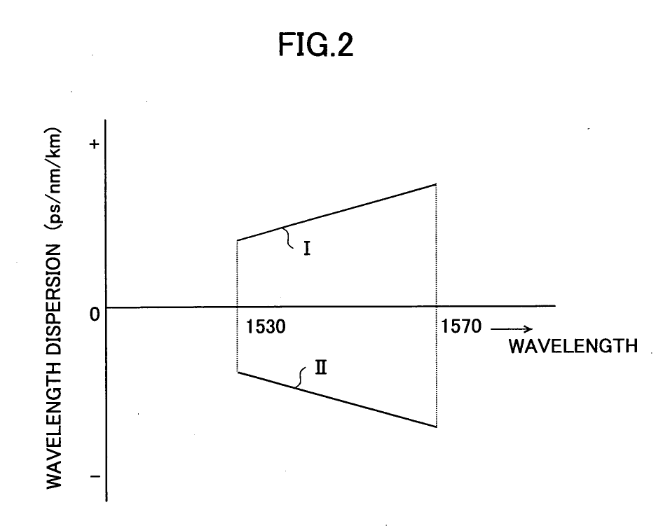

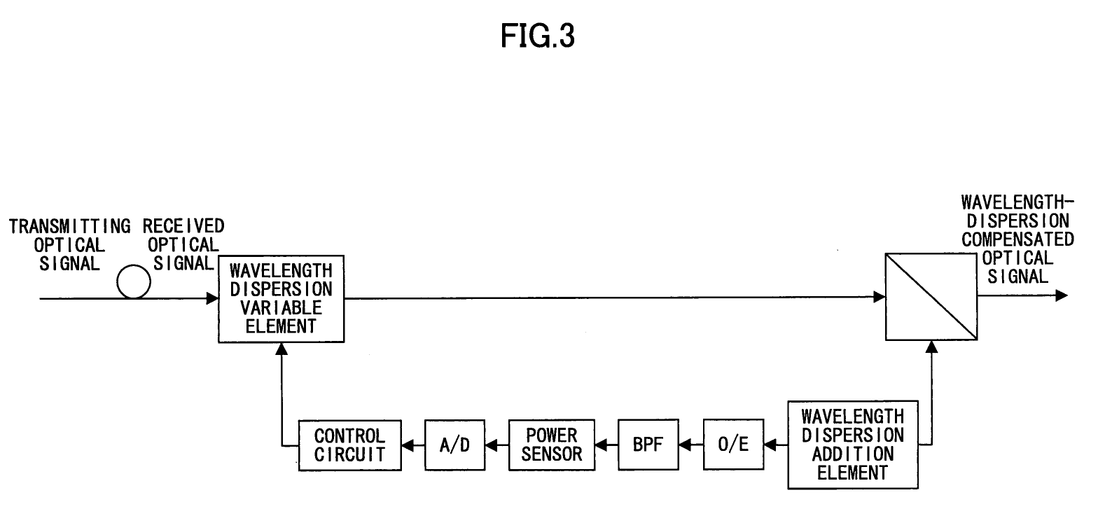

When the optical fiber transmission path 25 is the single mode fiber (SMF), it has positive wavelength dispersion illustrated by the solid line I in FIG. 2. In other words, in the single mode fiber, light having a longer wavelength propagates at a lower speed.

For this reason, as illustrated in FIG. 9, when light of different wavelengths λ1 and λ2 (assuming λ1<λ2) are transmitted through the optical fiber transmission path 25 (assuming its length is x), when the light arrives at the receiving end, the light having the wavelength λ1 and the light having the wavelength λ2 are at different positions in the time axis. If the propagation speeds of the light having the wavelength λ1 and the light having the wavelength λ2 are denoted to be v1 and v2, respectively, the difference r of the propagation time satisfies:
τ=x(1/v1−1/v2))

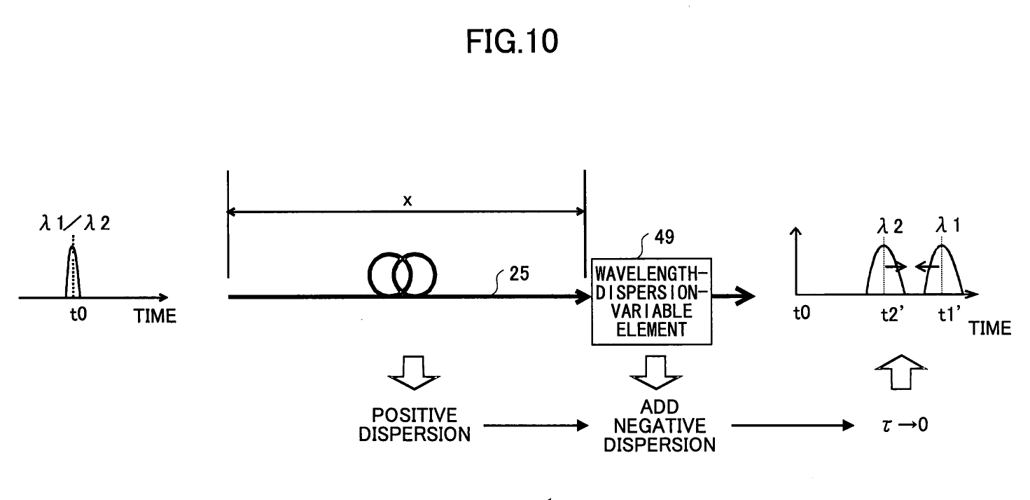

FIG. 10 is a schematic view showing the effect of the wavelength dispersion compensation when the wavelength-dispersion-variable element 49 is provided in the receiving end of the optical fiber transmission path 25.

Here, it is assumed that the optical fiber transmission path 25 is the single mode fiber (SMF), and it has positive wavelength dispersion as illustrated by the solid line I in FIG. 2.

Therefore, in order to compensate for the wavelength dispersion, it is sufficient to adjust the dispersion of the wavelength-dispersion-variable element 49 so that dispersion of the wavelength-dispersion-variable element 49 has the same absolute value as, but an opposite sign to the wavelength dispersion occurring in the optical fiber transmission path 25.

Due to this wavelength dispersion compensation, the propagation time difference between the light having the wavelength λ1 and the light having the wavelength λ2 vanishes in the signal output from the wavelength-dispersion-variable element 49.

In the present embodiment, in order to obtain optical signals having different wavelengths, because the ASE light from the optical amplifier 42 is utilized in wavelength dispersion compensation, it is not necessary to provide an additional optical signal besides the wavelength-multiplexed optical signal in the wavelength dispersion compensation controller 23 on the transmitting side, thus it is not necessary to provide a light source for generating optical signals for measurement use besides the pump LD 44.

Consequently, it is possible to reduce the size of the wavelength dispersion compensation controller 23, and suppress the cost of the optical WDM transmission system.

The elements described in the above correspond to the elements defined in the claims in the following way. The electrical switch 45 corresponds to the first switching unit defined in the claims, the optical band-pass filters 54 and 55 correspond to the extract unit, the dispersion control circuit 62 corresponds to the wavelength dispersion controller or the control unit in the wavelength dispersion controller, the optical switch 41 corresponds to the second switching unit, the optical switch 53 corresponds to the switching unit in the transmitting device, the optical-electrical converters (O/E) 56 and 57 correspond to the optical-electrical conversion unit, the differential amplifiers 58 and 59, the cumulative amplifier 60 correspond to the calculation unit, and the A/D converter 61 corresponds to the A/D conversion unit. The ASE light corresponds to the wavelength-dispersion-detection optical signal in the claims.

According to the present invention, it is possible to provide a method and devices for wavelength dispersion compensation capable of suppressing the cost and having a simple configuration without providing a light source on the transmitting side for generating optical signals for measurement use.

This patent application is based on

Japanese Priority Patent Application No. 2004-101101 filed on Mar. 30, 2004, the entire contents of which are hereby incorporated by reference.

1. A method of wavelength dispersion compensation, comprising the steps of:
intermittently outputting, in a transmitting device, excitation light to an optical amplifier for amplification of an optical signal to be transmitted;
outputting, in the transmitting device, an wavelength-dispersion-detection optical signal to an optical transmission path, said wavelength-dispersion-detection optical signal having a flat spectrum in a predetermined bandwidth;
extracting, in a receiving device, light components having different wavelengths from the wavelength-dispersion-detection optical signal received through the optical transmission path;
finding, in the receiving device, a difference in propagation time of the light components having different wavelengths through the optical transmission path; and
adjusting, in the receiving device, a value of wavelength dispersion of a wavelength-dispersion-variable element so that said difference becomes zero so as to compensate for wavelength dispersion in the optical transmission path.

2. The method as claimed in claim 1, wherein the transmitting device outputs a wavelength-multiplexed signal to the optical transmission path.

3. A transmitting device, comprising:
a first switching unit that intermittently outputs excitation light to an optical amplifier for amplification of an optical signal to be transmitted,
wherein said transmitting device outputs an wavelength-dispersion-detection optical signal generated in the optical amplifier to an optical transmission path.

4. The transmitting device as claimed in claim 3, further comprising:
a second switching unit that prevents the optical signal to be transmitted from being output to the optical amplifier.

5. A receiving device, comprising:
a wavelength-dispersion-variable element that performs wavelength dispersion compensation on an optical signal received through an optical transmission path;
an extraction unit that extracts light components having different wavelengths from an wavelength-dispersion-detection optical signal transmitted from the wavelength-dispersion-variable element;
a wavelength dispersion controller that finds a difference in propagation time of the light components having different wavelengths through the optical transmission path, and adjusts a value of wavelength dispersion of the wavelength-dispersion-variable element so that said difference becomes zero.

6. The receiving device as claimed in claim 5, further comprising:
a switching unit that prevents optical signal output from the wavelength dispersion controller from being output to the outside.

7. The receiving device as claimed in claim 5, wherein the wavelength dispersion controller comprises:
an optical-electrical conversion unit that converts a first light component having a first wavelength to a first detection signal, and converts a second light component having a second wavelength to a second detection signal, said first light component and said second light component being extracted by the extraction unit;
a calculation unit that sets a polarity of the first detection signal to be opposite to a polarity of the second detection signal, and sums the first detection signal and the second detection signal;
an A/D conversion unit that digitizes an output signal from the calculation unit; and
a control unit that finds a difference in propagation time of the first detection signal and the second detection signal, and adjusts a value of wavelength dispersion of the wavelength-dispersion-variable element so that said difference becomes zero.
